(19) United States
(12) Patent Application Publication
(10) Pub. No.: US 2011/0132883 A1
(43) Pub. Date: Jun. 9, 2011

(54) METHODS FOR PRECISE LASER MICROMACHINING

(75) Inventors: Zhongyan Sheng, Newton, MA (US); Xinbing Liu, Acton, MA (US); Hiroshi Nakaoku, Osaka (JP)

(73) Assignee: Panasonic Corporation, Osaka (JP)

(21) Appl. No.: 12/632,119

(22) Filed: Dec. 7, 2009

(51) Int. Cl. B23K 26/00

(52) U.S. Cl. 219/121.72

(57) ABSTRACT

Methods for laser micromachining a material are disclosed. The methods include machining a hole in the material by guiding a laser along a predefined path or applying the laser at a predefined beam angle. A shape of the hole is then characterized. Then, the difference between the shape of the hole and a target shape for the hole is calculated. The predefined path or beam angle of the laser is adjusted based on the difference between the shape of the hole and the target shape for the hole.

### FIELD OF THE INVENTION

The present invention relates generally to methods for laser micromachining and more particularly to modifying a machining path to control the shape of a machined feature.

### BACKGROUND OF THE INVENTION

Laser micromachining can be employed in many applications, such as the fabrication of a strip die for plasma display panel (PDP) phosphor printing. While precision micromachining is desirable in such applications, conventional laser micromachining methods may have difficulty achieving high accuracy (e.g., sub-micron accuracy) in the production of a target shape.

The shape of a laser machining result may be affected by a number of factors, such as the focused beam spot shape, and the accuracy of the beam movement. In order to achieve very high accuracy, it is generally desirable that the focused beam have a symmetric, round Gaussian shape, and at the same time, that the beam scan control be extremely precise. However, the focused beam may be far from perfect, for reasons such as non-ideal laser output, alignment error of the beam delivery system, or aberrations in optical elements such as lenses and mirrors. Additionally, the reaction of the laser photon with a substrate material can be highly nonlinear. All of these influence the shape of the laser machining results.

Thus, a single pulse of a laser applied to a substrate can hardly be regarded as a point or a round spot, especially when the desired shape is at the same order of the laser spot size. On the other hand, moving the focused laser beam spot along a tool path can be affected by, for example, the hysteresis of the actuator, or the response time delay between the tool path being followed and the real scanning trace. These factors increase the difficulty of achieving sub-micron accuracy by laser micromachining.

### SUMMARY OF THE INVENTION

Aspects of the present invention are directed to methods for laser micromachining a material. In accordance with an aspect of the present invention, one method for laser micromachining a material includes machining a hole in the material by guiding a laser along a predefined path. A shape of the hole is then characterized. Then, the difference between the shape of the hole and a target shape for the hole is calculated. The predefined path of the laser is adjusted based on the difference between the shape of the hole and the target shape for the hole.

In accordance with another aspect of the present invention, another method for laser micromachining a material is disclosed. The method includes machining a hole in the material by applying a laser at a predefined beam angle. A shape of the hole is then characterized. Then, the difference between the shape of the hole and a target shape for the hole is calculated. The predefined beam angle of the laser is adjusted based on the difference between the shape of the hole and the target shape for the hole

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features may be arbitrarily expanded or reduced for clarity. Included in the drawings are the following figures:

FIGS. 1A and 1B depict conventional round and straight-edge target shapes for laser-drilled holes;

FIGS. 2A and 2B depict exemplary round and straight-edge holes resulting from conventional laser drilling;

FIG. 3 depicts a flow chart illustrating an exemplary method for laser micromachining a material in accordance with aspects of the present invention;

FIG. 4A depicts a diagram of an exemplary laser path for drilling a round hole in accordance with aspects of the present invention;

FIG. 4B depicts a diagram of an exemplary adjusted laser path for drilling a round hole in accordance with aspects of the present invention;

FIG. 5 depicts an exemplary radius-angle graph of a hole shape in accordance with aspects of the present invention;

FIG. 6 depicts a flow chart illustrating another exemplary method for laser micromachining a material in accordance with aspects of the present invention; and

FIG. 7 depicts an exemplary system for laser micromachining in accordance with aspects of the present invention.

### DETAILED DESCRIPTION OF THE INVENTION

The exemplary methods disclosed herein are suitable for laser drilling of round holes or straight-edge holes in materials. Round hole drilling may be commonly used in printing devices. On the other hand, straight-edge holes may be desirable for providing longer device life time and more consistent printing performance. It is contemplated that aspects of the present invention may be used for laser micromachining holes of any shape in any material without departing from the spirit and scope of the present invention.

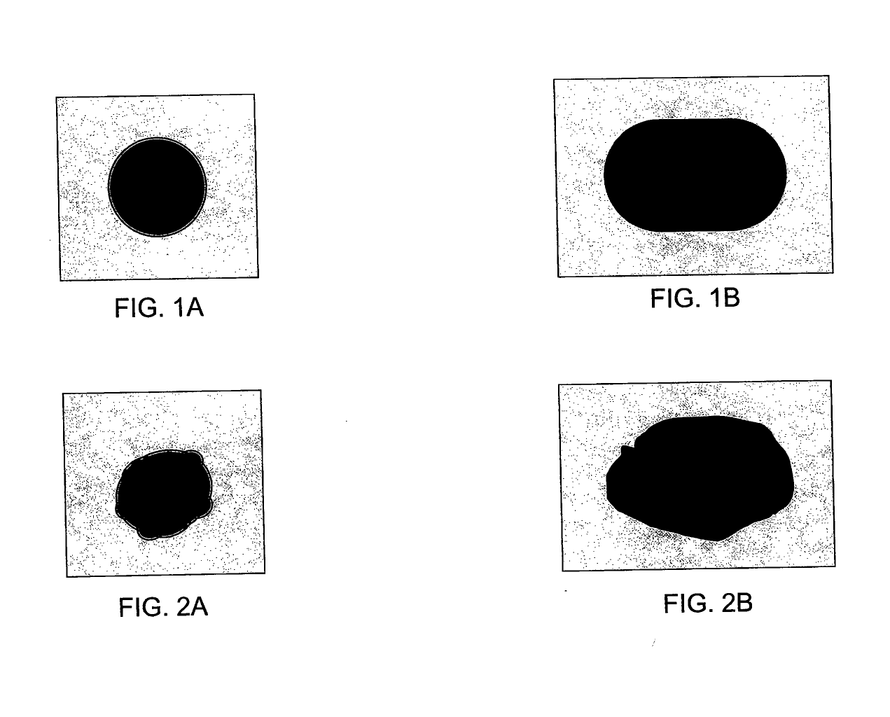

The exemplary methods disclosed herein may be particularly suitable for drilling holes having a diameter on the order of tens of micron, e.g., from about 10 μm to about 100 μm. Some printing equipment may have very stringent specifications governing the size and the shape of their holes. These specifications extend to both the entrance and exit holes in the materials. Conventional laser micromachining methods may be unable to meet these stringent specifications. For example, FIGS. 1A and 1B illustrate conventional round and straight-edge holes that may be specified for a material. Conventional laser micromachining methods may have difficulty achieving these target shapes due to aberrations in the laser beam or in the beam control. FIGS. 2A and 2B illustrated exemplary resulting holes from convention laser micromachining methods corresponding to the target holes of FIGS. 1A and 1B. As shown, conventional laser micromachining methods may not drill holes having shapes that meet the material specifications. In contrast, the disclosed laser micromachining methods achieve high precision to meet the material specifications.

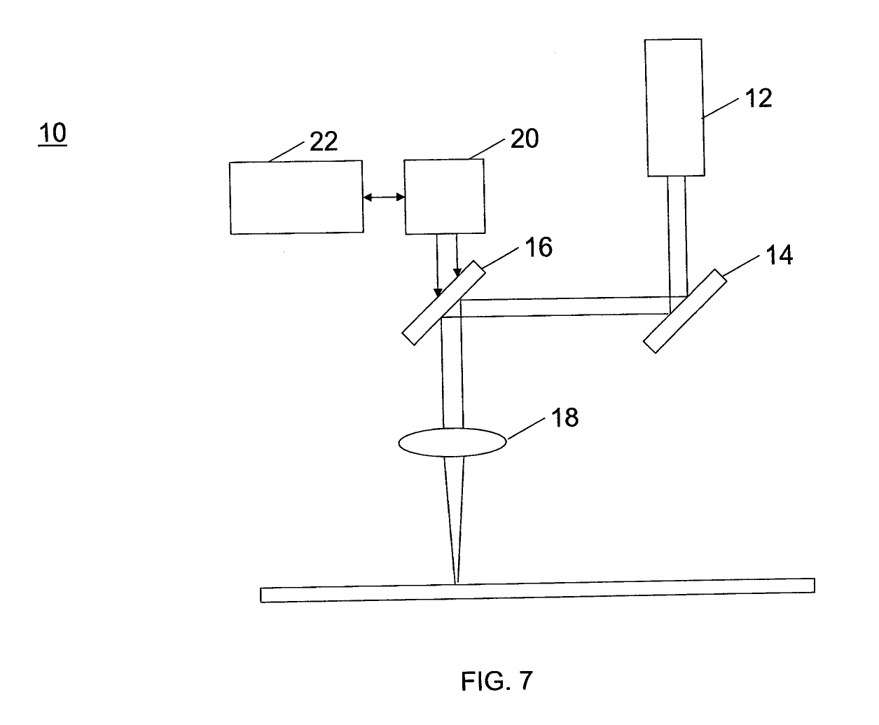

Referring now to the drawings, FIG. 7 is an exemplary system 10 for laser micromachining a material in accordance with aspects of the present invention. performing the methods of the present invention. System 10 may be used to perform the methods of the present invention. As an overview, system 10 includes a laser 12, a first beam steering element 14, a second beam steering element 16, a focusing element 18, an imaging element 20, and a processor 22. Additional details of system 10 are described below.

Laser 12 provides a laser beam for drilling a material. In an exemplary embodiment, laser 12 is an infrared pulse laser. Other suitable lasers includes UV lasers and green lasers. The pulse width of the lasers is desirably less than 1 ns but lasers having longer pulse widths may also be used. Other suitable lasers for laser micromachining will be known to one of ordinary skill in the art from the description herein.

First beam steering element 14 steers the beam from the laser. First beam steering element 14 is positioned to receive the beam from the laser 12 and steer the beam toward the second beam steering element 16. In an exemplary embodiment, first beam steering element 14 is a scan mirror. First beam steering element 14 may desirably be configured to move with respect to the laser beam.

Second beam steering element 16 steers the beam from the first steering beam element 16. Second beam steering element 16 is positioned to receive the beam from the first beam steering element 14 and steer the beam toward the focusing element 18. In an exemplary embodiment, second beam steering element 16 is also scan mirror. Second beam steering element 16 may also desirably be configured to move with respect to the laser beam. In one embodiment of the invention, steering element 16 may be a dichoric mirror exhibiting high reflectivity at the wavelength of the laser 12. At least one of the steering elements 14 and 16 may include actuators for tilting the steering element about the x and y axes. These actuators may be, for example, PZT elements. To control the angle at which the laser beam contacts the workpiece, it may be desirable for both of the steering elements 14 and 16 to include both x and y actuators and for the actuators to be synchronized.

Focusing element 18 focuses the laser beam from the second beam steering element 16. Focusing element 18 focuses the beam on the material to be drilled. In an exemplary embodiment, focusing element 18 is a focusing lens. Suitable lenses for focusing element 18 will be known to one of ordinary skill in the art from the description herein. For example, the lens 18 may be a telecentric f theta scan lens.

Imaging element 20 takes images of a hole drilled by system 10. Imaging element 20 may be positioned to take optical images of the hole along the same optical path as the laser beam. Accordingly, second beam steering element 16 may desirably be sufficiently transparent at visible wavelengths to allow imaging element 20 to obtain images of the material through element 16, as illustrated in FIG. 7. In an exemplary embodiment, imaging element 20 is a camera. Suitable cameras for imaging element 20 may include, for example conventional CCD and CMOS images. Other suitable cameras will be known to one of ordinary skill in the art from the description herein.

Processor 22 characterizes a shape of the hole. Processor 22 may receive data corresponding to optical images of the hole drilled by the laser beam from imaging element 20. Processor 22 may then characterize a shape of the hole based on the optical images of the hole. Suitable processors will be known to one of ordinary skill in the art from the description herein.

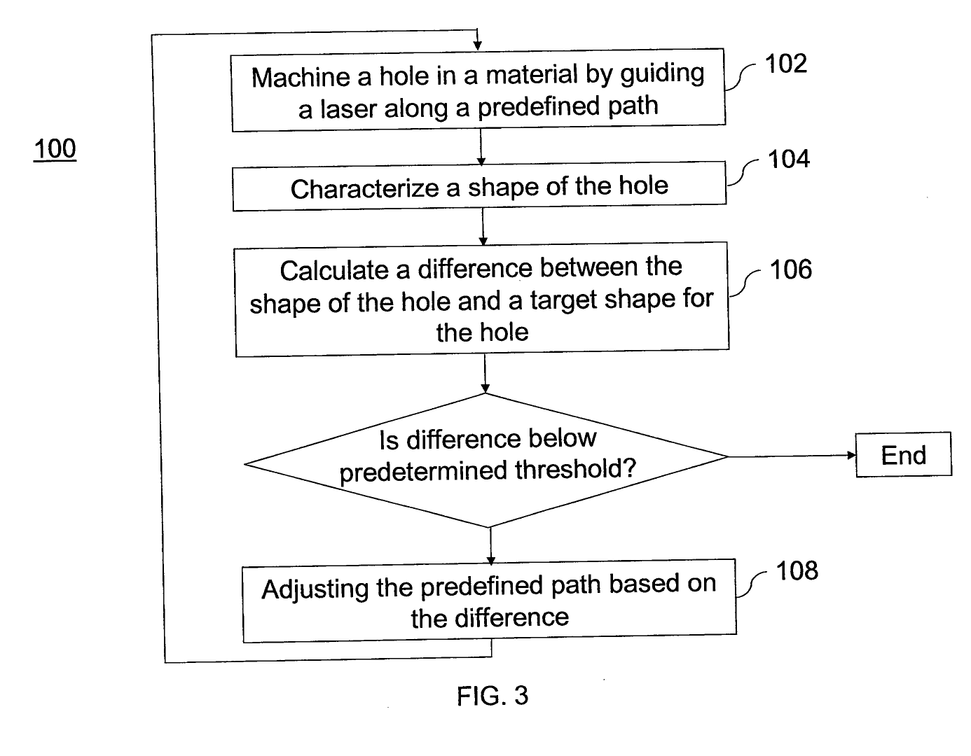

FIG. 3 is a flowchart illustrating an exemplary method 100 for laser micromachining a material in accordance with an aspect of the present invention. Method 100 achieves precisely shaped holes for stringent specifications by applying laser path correction. As an overview, method 100 includes machining a hole, characterizing the resulting shape of the drilled hole, calculating the difference between the resulting shape and the target shape in the specification, and adjusting the path of the laser based on the difference. For the purposes of illustration, the steps of method 100 are described herein with respect to the components of system 10. Additional details of method 100 are described below.

In step 102, a hole is machined in the material by guiding a laser along a predefined path. In an exemplary embodiment, laser micromachining system 10 is used to drill holes in a selected material. Other suitable laser micromachining systems will be known to one of ordinary skill in the art. The material may be any material having suitable material properties such as hardness, thickness, mechanical resistance, or chemical resistance, for example.

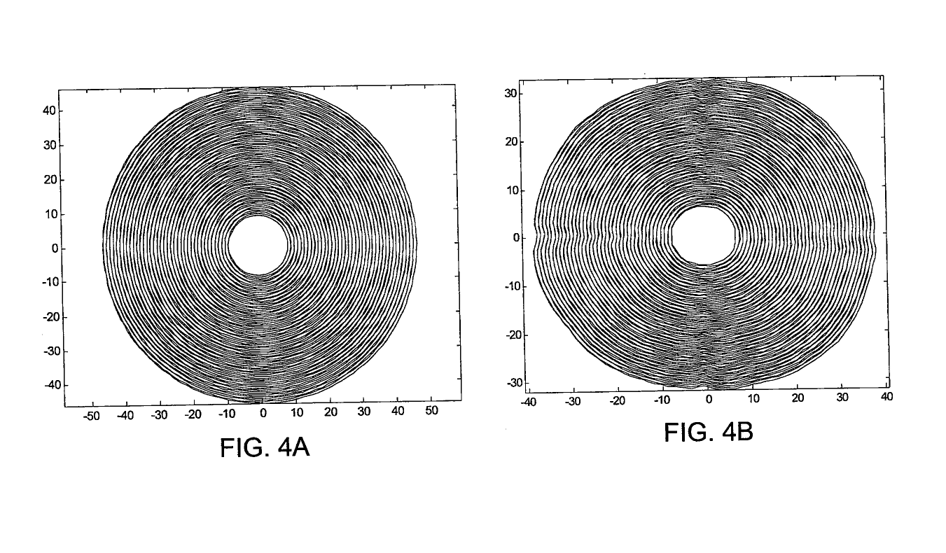

Laser micromachining system 10 includes a controller (not shown) for guiding the laser along the predefined path. The controller may be configured to move first and second beam steering elements 14 and 16 in order to change the path of the laser beam. The predefined path corresponds to the target shape for the hole being drilled. In an exemplary embodiment, the predefined path may be a spiralling path. An exemplary spiralling laser path for forming a circular hole is illustrated in FIG. 4A. The controller may form the spiraling path by tilting the first and second beam steering elements 14 and 16 relative to the laser beam. The controller of the micromachining system may further guide the laser beam along respective revolutions of the predefined spiralling path to form successively larger holes. By guiding the laser along an outwardly spiralling path, laser micromachining system 10 may form successively larger holes until a hole meeting the specified size is formed.

During this machining step, the laser may form a hole extending through the material. In this case, the laser hole will have an entrance shape on the side facing toward the laser and an exit shape on the side facing away from the laser.

In step 104, a shape of the hole is characterized. In an exemplary embodiment, the shape of the hole is characterized using imaging element 20 and processor 22. The processor 22 may characterize the shaped based on edge detection of the hole by imaging element 20. Imaging element 20 may record one or more images of the hole. The processor 22 can then use known image processing techniques to detect the hole's edges. For example, imaging element 20 may obtain optical images of the hole drilled by system 10. Processor 22 may then apply a matched spatial filter with a step response to the optical image. The filter may desirably be applied to the image in two directions. The filtering results may substantially correspond to the edges of the hole drilled by system 10. Other suitable techniques for edge detection of the hole will be understood by one of ordinary skill in the art from the description herein.

Further, it may be desirable that processor 22 perform some noise reduction in order to precisely define the edges of the hole. Additionally, in order to accurately detect the edges of the hole, it may be desirable or necessary to remove any debris remaining from the drilling step before obtaining images of the hole. Debris may be removed using an air or liquid flow, for example. Other suitable processes for removing debris from the hole will be known to one of ordinary skill in the art.

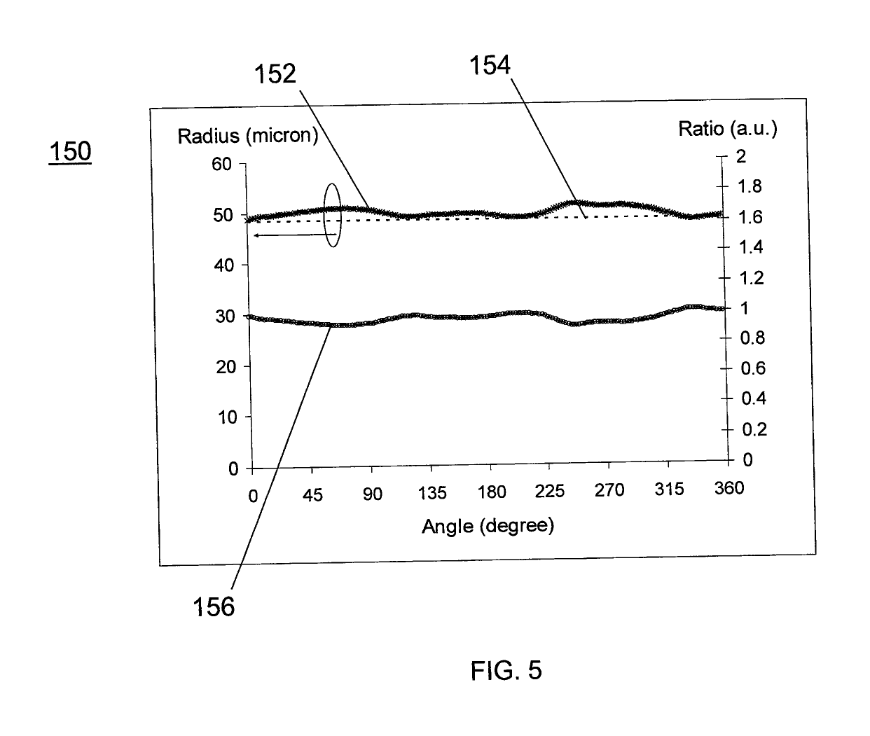

When the edges of the hole are detected, the processor 22 may then characterize the hole's shape. A suitable process for characterizing the shape of the hole is described herein. First, the processor 22 may find the center of the hole. One exemplary way of determining the hole's center is by determining it's center of gravity, which may be computed using known image processing techniques. Next, the processor 22 may select a number of sample points along the edge of the hole, and identify for those points their angle (with respect to a predetermined 0-degree direction) and radius with respect to the hole's center. Sample points may be taken, for example, for every degree around the edge of the hole. It will be understood, however, that sample points may be selected with greater or less frequency as desired. The processor 22 may then plot the sample points on a radius-angle graph. FIG. 5 illustrates an exemplary radius-angle graph 150 in accordance with aspects of the present invention. Line 152 of the radius-angle graph indicates the shape of the hole characterized by the processor over 360 degrees.

The specification may have different requirements for the entrance shape of the hole and the exit shape of the hole. Further, the entrance and exit shapes formed during step 102 may be different. Accordingly, the processor 22 may desirably characterize either one or both of the entrance shape of the hole and the exit shape of the hole. Line 152 in graph 150 may correspond to either the entrance shape or the exit shape of the hole. Additionally, graph 150 may include lines for both the entrance shape and the exit shape.

In step 106, a difference is calculated between the shape of the hole and the target shape for the hole. As described above, the specification for the material may include a target shape for the hole being machined. The target shape may correspond to the desired entrance shape and/or the desired exit shape for the hole. The shape may be, for example, a circular shape, or a shape having straight edges. In an exemplary embodiment, the processor 22 compares the characterized shape on the hole with a target shape for the hole. With further reference to FIG. 5, graph 150 also includes a line 154 corresponding to the target shape of the hole. As with line 152, line 154 may correspond to either the entrance shape or the exist shape of the hole. As illustrated, line 154 has a constant radius over 360 degrees, thus corresponding to a circular hole. The difference between the shape of the hole and the target shape is therefore easily observed from the gaps between lines 152 and 154.

In step 108, the predefined path is adjusted based on the difference between the shape of the hole and the target shape for the hole. The predefined path is adjusted so that the resulting hole more closely matches the shape of the target hole. In an exemplary embodiment, the processor 22 computes a compensation ratio for each sample point along the radius-angle graph 150.

The compensation ratio may desirably correspond to the degree the radius of the hole must be adjusted in order to match the target hole. For example, for a given angle where the target radius is 90 μm and the actual radius is 100 μm, the compensation ratio may be 0.90. For some systems it may be desirable to overcompensate the adjustment to achieve faster convergence. With further reference to FIG. 5, graph 150 includes a line 156 corresponding to the desired compensation ratio for adjusting the predefined tool path. As illustrated on graph 150, for those angles at which the characterized shape of the hole (line 152) matches the target shape of the hole (line 154), the compensation ratio (line 156) is desirably 1.0. In any event, it will be understood that as the difference between the hole shape and the target shape decreases, the compensation ratio will desirably be reduced.

Once the processor computes a compensation ratio, the predefined path for the laser may be adjusted based on the compensation ratio. For example, the controller of system 10 may move beam steering elements 14 and 16 in order to adjust the predefined path of the laser beam. The angle at which the beam contacts the material may be adjusted based on the angle of first and second beam steering elements 14 and 16. The greater the angle of the steering elements (with respect to their normal position), the farther removed from the lens axis the beam will be, and the greater the angle (with respect to normal incidence) that will be formed by the laser where it contacts the material. Thus, changing the angles of first and second beam steering elements 14 and 16 may be used to change the position of the laser beam where it contacts the material, and thereby, the radius of the predefined path. Where the compensation ratio is below 1 at a given angle, the predefined path may be adjusted so that the radius at the given angle is increased. Similarly, where the compensation ratio is above 1 at a given angle, the predefined path may be adjusted so that the radius at the given angle is decreased. FIG. 4B illustrates an exemplary adjusted predefined laser path corresponding to the spiralling laser path disclosed in FIG. 4A. This new predefined path will desirably produce a hole having a shape closer to the target shape of the specification.

It may be necessary to repeat method 100 multiple times in order for the resulting shape of the hole to sufficiently match the target shape from the specification. Accordingly, method 100 may further require repeating steps 102-108 until the difference between the shape of the hole and the target shape is below a predetermined threshold. The predetermined threshold for the difference may be determined by the specification, e.g., the target shape including a range or variance. Alternatively, the predetermined threshold may be a length, e.g., 0.5 μm. Further, the predetermined threshold may be determined such that steps 102-108 are repeated until the difference between the hole shape and the target shape no longer decreases with each successive run. When the difference falls below this predetermined threshold, method 100 may be completed. At this stage, the adjusted predefined path of the laser may produce holes having a shape precisely corresponding to the target shape of the holes. Thus, method 100 may be used as described above to drilling holes to meet stringent specifications.

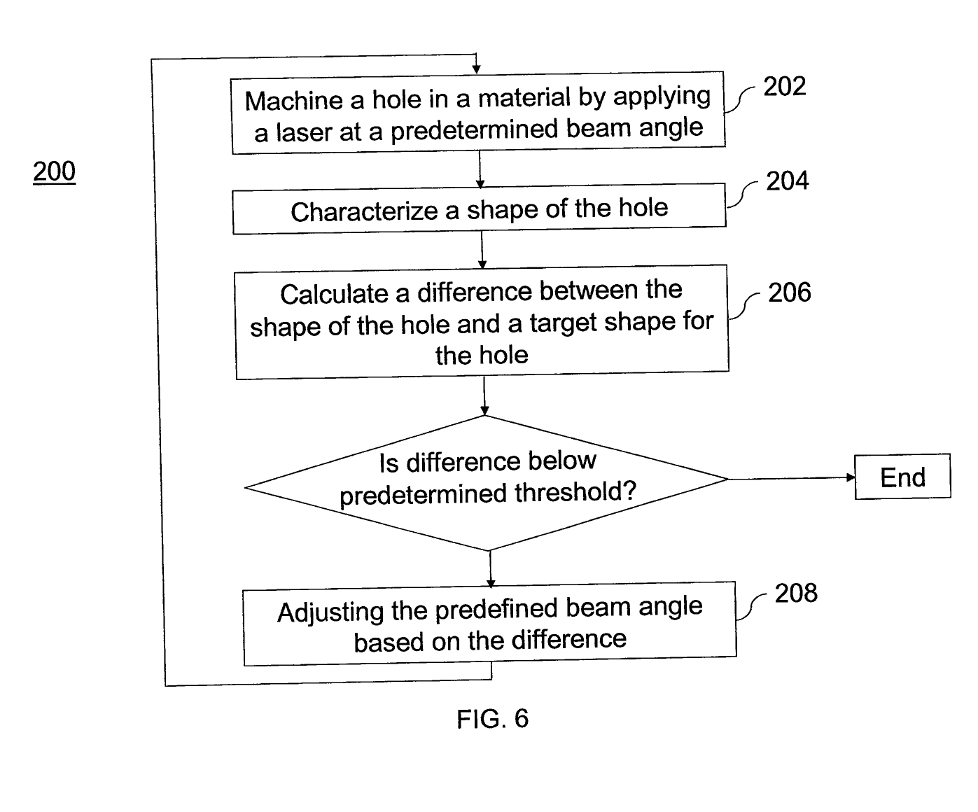

Referring now to the drawings, FIG. 6 is a flowchart illustrating another exemplary method 200 for laser micromachining a material in accordance with an aspect of the present invention. Method 200 achieves precisely shaped holes for stringent specifications by applying laser beam angle correction. As an overview, method 200 includes machining a hole, characterizing the resulting shape of the drilled hole, calculating the difference between the resulting shape and the target shape in the specification, and adjusting the angle of the laser beam based on the difference. For the purposes of illustration, the steps of method 100 will be described herein with respect to the components of system 10. Additional details of method 200 are described below.

In step 202, a hole is machined in the material by applying a laser at a predefined beam angle. In an exemplary embodiment, laser micromachining system 10 is used to drill holes in a selected material, as described above with respect to step 102. The laser micromachining system 10 includes a controller (not shown) for applying the laser beam at the predefined angle. The system further includes first and second beam steering elements 14 and 16 for producing the desired beam angle. The predefined angle will determine whether there are differences between the entrance and exit shapes for the hole. For example, the target entrance and exit shapes may desirably be the same (i.e., for a hole having no taper). Thus the predefined angle will be chosen to produce the same shape on both sides of the material.

In step 204, a shape of the hole is characterized. In an exemplary embodiment, processor 22 characterizes the shape of the hole using image processing of optical images from imaging element 20, as described above with respect to step 104. The processor 22 characterizes both the entrance shape of the hole and the exit shape of the hole. As described above, lines corresponding to the entrance shape and the exit shape may be illustrated in a radius-angle graph.

In step 206, a difference is calculated between the shape of the hole and the target shape for the hole. In an exemplary embodiment, the processor 22 compares the characterized entrance and exit shapes of the hole with the target shapes for the hole, as described above with respect to step 106.

In step 208, the predefined beam angle is adjusted based on the difference between the shape of the hole and the target shape for the hole. In an exemplary embodiment, first and second beam steering elements 14 and 16 are moved to adjust the predefined beam angle so that the resulting entrance and exit shapes more closely matches the shape of the target hole, as described above with respect to step 108.

For example, the controller of system 10 may move beam steering elements 14 and 16 in order to adjust the predefined angle of the laser beam. The angle at which the beam contacts the material may be adjusted based on the angle of first and second beam steering elements 14 and 16. The greater the angle of the steering elements (with respect to their normal position), the farther removed from the lens axis the beam will be, and the greater the angle (with respect to normal incidence) that will be formed by the laser where it contacts the material. Thus, changing the angles of first and second beam steering elements 14 and 16 may be used to change the angle of the laser where it contacts the material, and thereby, the radius of the predefined path. For a given exit hole shape, if a sample point along the entrance hole has a radius that is too large, the beam angle may need to be increased. Similarly, for a given exit hole shape, if a sample point along the entrance hole has a radius that is too small, the beam angle may need to be decreased.

The processor 22 may also compute a compensation ratio for each point, as described above. It will be understood that as the difference between the hole shape and the target shape decreases, the compensation ratio will desirably be reduced. Once the processor 22 computes a compensation ratio, the predefined beam angle for the laser may be adjusted based on the compensation ratio.

It may be necessary to repeat method 200 multiple times in order for the resulting shape of the hole to sufficiently match the target shape from the specification. Accordingly, method 200 may further require repeating steps 202-208 until the difference between the shape of the hole and the target shape is below a predetermined threshold, as described above with respect to method 100.

It may further be desirable to perform both method 100 and method 200 in order to precisely drill holes using laser micromachining. Methods 100 and 200 may be performed serially, i.e., performing method 100 and then method 200. In the alternative, it will be understood by one of ordinary skill in the art that both methods could be performed simultaneously. In this respect, both the predefined laser path and the predefined beam angle could be continuously adjusted together until a hole is drilled that precisely corresponds to the specification.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for laser micromachining a material, the method comprising the steps of:
a) machining a hole in the material by guiding a laser along a predefined path;
b) characterizing a shape of the hole;
c) calculating a difference between the shape of the hole and a target shape for the hole; and
d) adjusting the predefined path based on the difference between the shape of the hole and the target shape for the hole.

2. The method of claim 1, further comprising the steps of:
e) repeating steps (a)-(d) until the difference between the shape of the hole and the target shape for the hole is less than a predetermined threshold.

3. The method of claim 1, wherein step (a) comprises:
a) machining a hole in the material by guiding the laser through a revolution of a predefined spiraling path.

4. The method of claim 1, wherein step (b) comprises:
b) characterizing the shape of the hole based on edge detection of the hole by image processing.

5. The method of claim 4, wherein step (b) comprises:
b) characterizing the shape of the hole by (b1) detecting an edge of the hole in an optical image; (b2) computing a center of gravity of the hole; (b3) selecting a predetermined number of sample points along the edge of the hole; and (b4) determining a radius for the predetermined number of sample points.

6. The method of claim 1, wherein steps (b)-(c) comprise:
b) characterizing an entrance shape of the hole; and
c) calculating a difference between the entrance shape of the hole and a target entrance shape for the hole.

7. The method of claim 1, wherein steps (b)-(c) comprise:
b) characterizing an exit shape of the hole; and
c) calculating a difference between the exit shape of the hole and a target exit shape for the hole.

8. The method of claim 1, wherein the adjusting step comprises:
d1) determining a compensation ratio based on the difference between the shape of the hole and the target shape for the hole; and
d2) adjusting the predefined path based on the compensation ratio.

9. The method of claim 1, wherein the target shape for the hole is a circle.

10. The method of claim 1, wherein the target shape for the hole has straight edges.

11. A method for laser micromachining a material, the method comprising the steps of:
a) machining a hole in the material by applying a laser at a predefined beam angle;
b) characterizing a shape of the hole;
c) calculating a difference between the shape of the hole and a target shape for the hole; and
d) adjusting the predetermined beam angle based on the difference between the shape of the hole and the target shape for the hole.

12. The method of claim 11, further comprising the steps of:
e) repeating steps (a)-(d) until the difference between the shape of the hole and the target shape for the hole is below a predetermined threshold.

13. The method of claim 11, wherein step (b) comprises:
b) characterizing the shape of the hole based on edge detection of the hole by image processing.

14. The method of claim 13, wherein step (b) comprises:
b) characterizing the shape of the hole by (b1) detecting an edge of the hole in an optical image; (b2) computing a center of gravity of the hole; (b3) selecting a predetermined number of sample points along the edge of the hole; and (b4) determining a radius for the predetermined number of sample points.

15. The method of claim 11, wherein steps (b)-(c) comprise:
b) characterizing an entrance shape of the hole; and
c) calculating a difference between the entrance shape of the hole and a target entrance shape for the hole.

16. The method of claim 11, wherein steps (b)-(c) comprise:
b) characterizing an exit shape of the hole; and
c) calculating a difference between the exit shape of the hole and a target exit shape for the hole.

17. The method of claim 11, wherein the adjusting step comprises:
d1) determining a compensation ratio based on the difference between the shape of the hole and the target shape for the hole; and
d2) adjusting the predetermined beam angle based on the compensation ratio.

18. The method of claim 11, wherein the target shape for the hole is a circle.

19. The method of claim 11, wherein the target shape for the hole has straight edges.
